(19) United States
(12) Patent Application Publication
(10) Pub. No.: US 2009/0202317 A1
(43) Pub. Date: Aug. 13, 2009

(54) SELF-LOCKING NUT FOR SECURING COMPONENTS FOR SPECTACLES AND METHOD OF MANUFACTURE THEREOF

(75) Inventor: Massimiliano Tabacchi, Padova (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Safilo Societa Azionaria Fabbrica Italianna Lavorazione Occhiali S.p.A, Pieve Di Cadore (BL) (IT)

(21) Appl. No.: 12/304,442

(22) PCT Filed: Jun. 20, 2006
(86) PCT No.: PCT/IT2006/000467

§ 371 Date: Dec. 11, 2008

(51) Int. Cl. F16B 39/286; B21D 53/24

(52) U.S. Cl. 411/274; 470/19

(57) ABSTRACT

A self-locking nut is described for securing components for spectacles, including a body with an internally-threaded through-hole extending along an axial direction, the body having at least one recess extending transversely to the axial direction and intersecting at least partly the threaded hole, the recess delimiting at least a first and a second portion of the body connected together and axially separated. The main parts of the sections of the threaded hole of the respective first and second portions are axially misaligned in relation to each other along the axial direction and arranged so as to return in substantially reciprocal alignment when the portions are screwed onto a threaded shank. Elastic deformation generated in the portions of the nut, as a result of the return to the aligned position of the threaded sections, being such as to increase the tightening action of the nut on the threaded shank.

### TECHNICAL FIELD

The present invention concerns a self-locking nut for securing components for spectacles having the characteristics described in the preamble of Main claim 1. The invention also concerns a method of manufacture of a self-locking nut according to claim 13.

### TECHNOLOGICAL BACKGROUND

This invention particularly concerns the specific technical field of spectacles, in which nuts of the above-mentioned type are used to secure very diverse components. Purely by way of example, there are screw fixings for frame elements such as attachment pieces or central nose bridges, with the corresponding lenses of rimless spectacles or threaded pin fixings comprising hinge pins in traditional spectacle frames. In these applications the fixing nut must have characteristics such as to guarantee effective securing and prove to be reliable in maintaining the securing action so as to counteract any slackening off that may compromise the functionality of the spectacles. These features are also required in applications where the components of the securing systems have very small overall dimensions and consequently involve the use of extremely small fixing nuts.

### DESCRIPTION OF THE INVENTION

The main object of this invention is to provide a self-locking nut for securing components for spectacles which offers an improved and more reliable securing action and which at the same time is of simple construction, a further object being therefore also to provide a method of manufacture that meets this requirement.

These and other objects which will emerge more clearly below are achieved by a self-locking nut and a method of manufacture thereof achieved in accordance with the accompanying claims.

### BRIEF DESCRIPTION OF THE DRAWINGS

Further features and advantages of the invention will emerge from the following detailed description of some of its preferred embodiments which are shown, by way of non-limiting examples, with reference to the accompanying drawings in which:

FIGS. 1 and 2 are front and side elevations of a first example of a fixing nut made according to the invention;

FIG. 3 is a side elevation of the nut shown in the preceding figures in a stage of the method of manufacture thereof;

FIGS. 4, 5 and 6 are side elevations of the nut in the preceding figures in separate stages of screwing onto a threaded shank;

FIG. 7 is a partial section of a securing system between a lens and a spectacle frame element in which the nut shown in the preceding figures is used;

FIGS. 8 and 9 are front and side elevations respectively of a second example of a securing nut made according to the invention;

FIG. 10 is a side elevation of the nut shown in FIGS. 8 and 9 in a stage of the method of manufacture thereof;

FIGS. 11, 12 and 13 are side elevations of the nut shown in FIGS. 8 and 9 in separate stages of screwing onto a threaded shank;

FIGS. 14 and 15 are front and side elevations respectively of a third example of a fixing nut made according to the invention, shown in a stage of the method of manufacture thereof;

FIG. 16 is a side elevation of the nut shown in FIGS. 14 and 15 in a further stage of the method of manufacture thereof;

FIG. 17 is a side elevation of the nut shown in FIGS. 14 and 15;

FIGS. 18 and 19 are side elevations of the nut shown in FIG. 16 in separate stages of screwing onto to threaded shank;

FIGS. 20 and 21 are front and side elevations of a fourth example of a fixing nut made according to the invention, shown in a stage of the method of manufacture thereof;

FIG. 22 is a side elevation of the nut shown in FIGS. 20 and 21 in a further stage of the method of manufacture thereof;

FIG. 23 is a side elevation of the nut shown in FIGS. 20 and 21;

FIGS. 24 and 25 are side elevations of the nut shown in FIG. 23 in separate stages of screwing onto a threaded shank;

FIG. 26 is a side elevation of a fifth example of a fixing nut made according to the invention;

FIG. 27 is a front elevation of the nut shown in FIG. 26;

FIG. 28 is a view of the nut shown in FIGS. 26 and 27 in a stage of screwing onto a threaded shank.

### PREFERRED EMBODIMENTS OF THE INVENTION

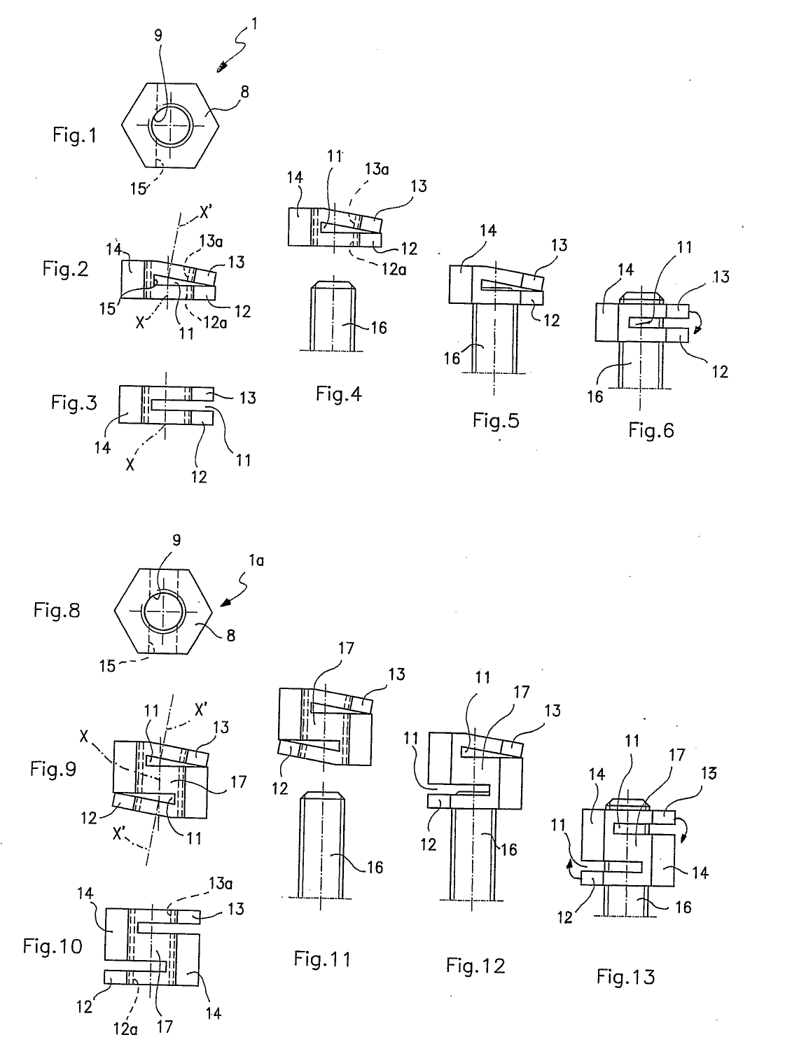

Referring initially to FIGS. 1 and 2, 1 shows as a whole a first example of a fixing nut for securing components for spectacles according to the present invention.

The nut 1 is self-locking and is designed to be used in securing systems between components for spectacles, particularly for screw fixings for lens frame elements (such as attachment pieces or central connecting nose bridges) or for securing the arms of spectacles to the corresponding hinged attachment pieces in which the threaded pin can also act as a hinge pin. FIG. 7 shows a typical application in which the nut 1 is used to secure a spectacle lens 2 to an attachment piece 3, on which is hinged an arm 4, by means of a screw 5 passing through a hole 6 in the lens and onto which the nut 1 is screwed from the opposite side. It is understood that the securing system shown in FIG. 7 represents one of the possible applications in which the nut according to the invention can be used, the latter being generally usable whenever a screw fixing with a corresponding lock nut is required.

Nut 1 comprises a body 8 with a through-hole 9, threaded internally and also extending in an axial direction, shown by axis X in the figures. The profile 10 of the outer surface of the body 1 is polygon-shaped, for example hexagonal, to enable a spanner to be used to tighten the nut.

The body 8 of the nut also has a recess 11 extending transversely in relation to axis X, preferably perpendicular to the said axis, until most of hole 9 has been intersected, as shown in FIG. 2. The said recess 11 delimits within body 8 of the nut a first and a second portion 12, 13, which remain joined together by means of a connecting area 14 not affected by the recess 11.

The first and second portion 12, 13 are axially separated from each other by the recess 11, which extends radially through the body 8 until beyond the corresponding median diametral plane of the nut containing the axis X, ending in a surface 15 at the bottom of the recess, with a straight profile in the view shown in FIG. 1.

The portion 13 is also transversely inclined in relation to portion 12 facing it, so that the said portions are extended to converge towards each other on the part diametrically opposite the connection area 14. Thanks to this configuration, most parts of the threaded sections of the hole 9 in the respective portions 12, 13, shown by 12a, 13a respectively, are axially misaligned in relation to each other, along axis X, and arranged to return in substantially reciprocal axial alignment when the portions 12, 13 are both being screwed onto a threaded shank, shown by 16 in the figures. As will emerge clearly below, thanks to the elastic return to the aligned position of the said sections 12a, 13a, the tightening action of the nut is increased by the effect of the greater stresses present between the meshing threads of the nut and the screw.

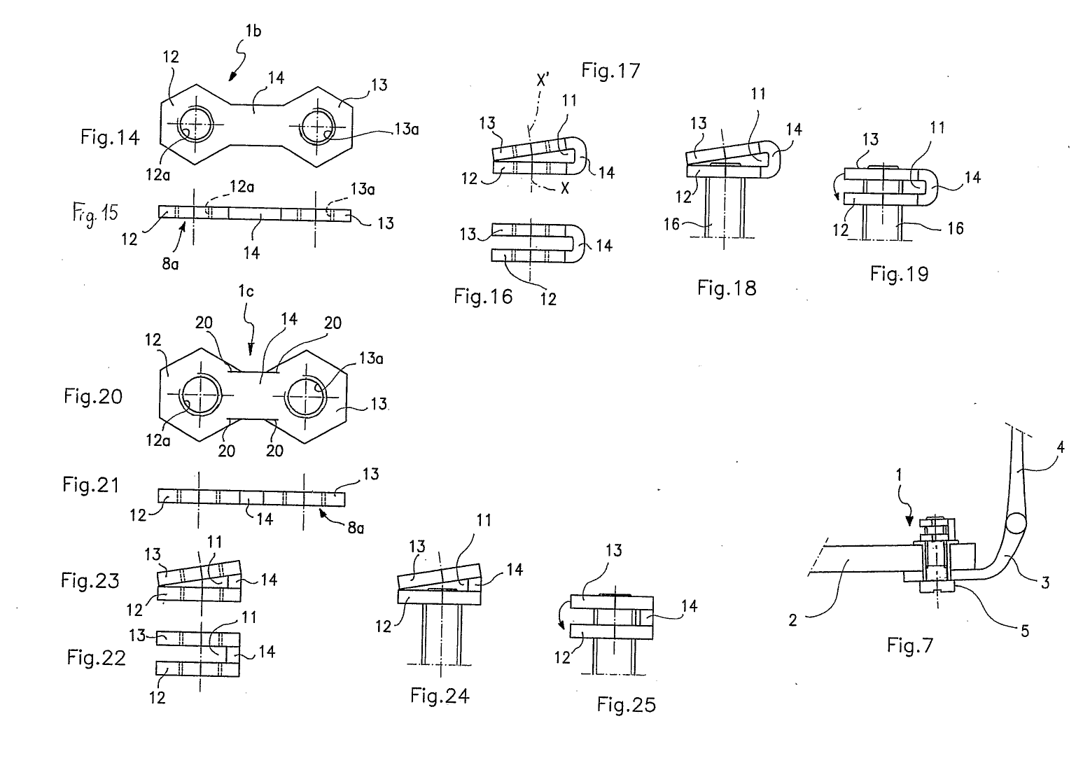

In FIG. 2, X′ shows the direction of axial development of the threaded section 13a, which is misaligned in relation to section 12a coaxial with axis X, a preset angulation being defined between axes X and X′ and correlated to the degree of deformation imposed which causes portion 13 to converge onto portion 12. FIGS. 4 to 6 show the successive stages during the screwing operation of the nut, from the unscrewed condition of FIG. 4, through an intermediate condition of FIG. 5 in which only portion 12 is screwed onto the threaded shank 16, until the condition of FIG. 6, in which both portions are screwed onto the screw, with portions 12, 13 and their respective threaded sections 12a, 13a brought into substantially reciprocal alignment. The nut in this example is made by first performing a transverse cut through body 8, so as to create the recess 11 delimiting portions 12 and 13, obtaining in this first stage the configuration shown in FIG. 3, in which the said portions 12, 13 are parallel and separated from each other and the respective threaded sections 12a, 13a of hole 9 are reciprocally aligned and coaxial with axis X.

In a subsequent stage of the method of manufacture, portion 13 is deformed plastically by bending to an extent such as to obtain the final configuration shown in FIG. 2 with the portions converging towards each other and the corresponding threaded sections 12a, 13a reciprocally misaligned.

It is also advantageous that, subsequent to the bending stage, the nut should undergo a tempering heat- or, more generally, hardening treatment of portions 12, 13, which consequently tends to increase the extent of elastic return during the nut screwing stage. Performing heat treatment subsequent to cutting also advantageously facilitates the removal of material during the cutting stage, a stage in which the not yet hardened material offers less resistance to the cutting action.

FIGS. 8 to 13 show a second embodiment of the nut according to the invention, generally indicated by 1a, in which parts similar to those referred to in the preceding example bear the same reference numerals.

Nut 1a differs mainly from that of the previous example in that it has a pair of recesses 11, axially separated from each other, as clearly shown in FIG. 9.

The pair of recesses 11 delimit in body 8 a first, second and third portion, shown respectively by 12, 13 and 17, portion 17 being between the recesses 11, portions 12 and 13 being defined by parts which are axially opposite the third portion 17.

The recesses 11 also extend perpendicular to axis X, from diametrically opposite areas of body 8 and extend radially beyond the diametral median plane containing axis X (transverse to this direction of radial development) to end in a corresponding surface 15 at the bottom of the respective recess. Advantageously the threaded section 17a of the hole in portion 17 is coaxial with axis X, whereas the respective threaded sections 12a, 13a of the corresponding portions 12, 13 are misaligned, along axis X, in relation to section 17a and are also arranged so as to return in substantially reciprocal axial alignment when all the portions are screwed onto the threaded shank 16 (FIG. 13).

Portions 12 and 13 extend to converge onto the central portion 17, at the part diametrically opposite the area connecting with portion 17.

Preferably, both threaded sections 12a, 13a are inclined with equal angulation in relation to axis X.

FIGS. 11 to 13 show the stages that succeed each other in the screwing operation of nut 1a, from the unscrewed condition of FIG. 11, through an intermediate condition of FIG. 12 in which only portion 12 is screwed onto the threaded shank 16, until the condition of FIG. 13, in which all of the portions of the nut are screwed onto the screw, with portions 12, 13 and their respective threaded sections 12a, 13a brought into substantially reciprocal alignment. Note how, with regard to nut 1, the increased tightening action that can be achieved by nut 1a is much greater in that it can be achieved both between portion 12 and 17 and, in addition, between portions 13 and 17.

The nut in this example is made by first making a pair of opposing transverse cuts in the body 8, so as to create the recess 11 delimiting portions 12, 13 and 17, obtaining in this first stage the configuration shown in FIG. 10, in which portions 12, 13 are parallel and separated in relation to portion 17, and the respective threaded sections 12a, 13a of hole 9 are reciprocally aligned and coaxial with axis X.

In a subsequent stage of the method of manufacture, both portions 12 and 13 are plastically deformed by means of respective bending of an extent such as to obtain the final configuration shown in FIG. 9 with the said portions converging towards the central portion 17 and the corresponding threaded sections 12a, 13a in reciprocal misalignment.

It is also advantageous that, subsequent to the bending stage, the nut should undergo a tempering heat- or, more generally, hardening treatment, which consequently tends to increase the extent of the elastic return induced during the nut screwing stage. Performing heat treatment subsequent to cutting also advantageously facilitates the removal of the material during the cutting stage, a stage in which the not yet hardened material offers less resistance to the cutting action.

FIGS. 14 to 19 show a third example of an embodiment of the nut according to the invention, generally shown by 1b, in which parts similar to those referred to in the preceding example bear the same reference numerals.

Nut 1b differs mainly from that of the first example in that nut body 8 is obtained by bending an elongated base 8a in which the first and second portion 12, 13 are substantially coplanar with each other and with a connecting area 14.

More particularly, base 8a is advantageously made by cutting or stamping a sheet of material, obtaining portions with a hexagonal profile 12 and 13 connected together by the connecting area 14. By means of subsequent drilling of each of portions 12, 13, appropriately threaded respective holes are made, defining the respective sections 12a, 13a.

In a subsequent stage of the method, base 8a is subjected to a bending process, at the connecting area 14, that brings portion 12 into a position that is basically facing portion 13, with the corresponding threaded holes coaxial with each other. This configuration is shown in FIG. 16, from which, by further bending, the configuration in FIG. 17 is achieved, in which portion 13 is bent over to converge towards portion 12 and the corresponding threaded sections 12a, 13a are reciprocally misaligned, along axis X.

FIGS. 18 and 19 show two stages that succeed each other on screwing the nut onto the shank 16, operationally similar to those shown in FIGS. 5 and 6 respectively in relation to nut 1.

Lastly, FIGS. 20 to 25 show a fourth embodiment of the nut according to the invention, shown as a whole by 1c, which represents a variation of nut 1b.

In this example, the main difference with nut 1c lies in the fact that the elongated base 8a which is bent to create nut 1c, has a connecting area 14 with a shorter longitudinal extension.

Thanks to this increased dimensional compactness, incisions 20 are made between the connecting area 14 and the corresponding portions 12 and 13, to facilitate the bending of area 14 so as to obtain the final configuration shown in FIG. 23. The incisions 20 are advantageously made along the opposing side edges of area 14, at the connection with the respective portions 12 and 13, as is clearly shown in FIG. 20.

FIGS. 24 and 25 show two successive nut screwing stages, operationally similar to those shown in FIGS. 18 and 19 respectively of the preceding example.

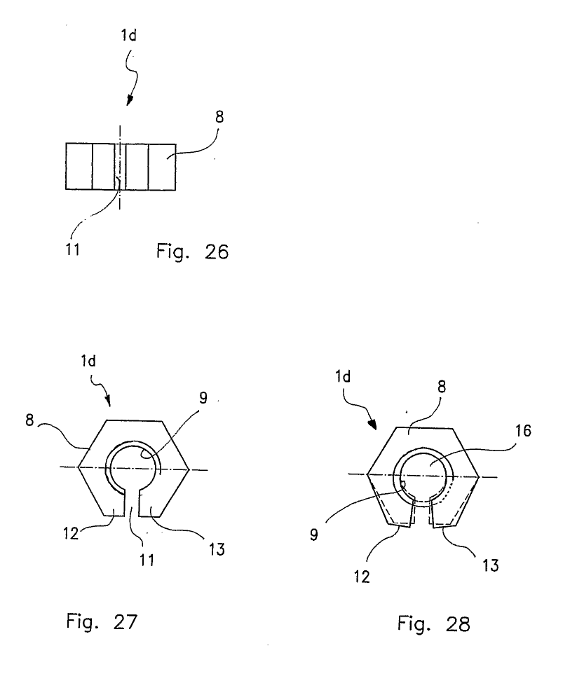

FIGS. 26 to 28 show a fifth embodiment of the self-locking nut made according to the invention, shown as a whole by 1d, in which parts similar to those of the preceding examples bear the same reference numerals. Nut 1d is characterised mainly for the fact that the recess 11 extends longitudinally through body 8, parallel to the axial direction X, affecting the entire longitudinal development of the body and being open at the opposite axial ends thereof.

Recess 11 also intersects the threaded hole 9 delimiting two opposing portions 12, 13 of body 8, extending away from recess 11.

Furthermore, the threaded diameter of axial hole 9 is smaller than the diameter of the screw (of shank 16) onto which the nut is to be screwed. In this way, the elastic deformation caused during screwing due to the effect of the difference in the mating thread diameters, and tending reciprocally to separate portions 12, 13 of the nut, is such as to increase the tightening action of the nut on the threaded shank 16.

FIG. 28 shows the nut 1d during the stage of screwing onto the threaded shank 16, the end edges of portions 12, 13 in the undeformed condition being shown by dotted lines. Thanks to the under-sizing of hole 9 of the nut an increased tightening effect is therefore achieved, caused by the elastic return of the deformed portions during screwing of the nut. Advantageously, the recess 11 in nut 1d is obtained by a longitudinal cut through the nut body 8.

Note also how the nut according to the invention, in the embodiments described, can be made either of metal material or plastic material and be a composite or “filled” with fibres or other similar elements.

In the case of metal embodiments, the tempering or hardening treatment may or may not be applied and is performed in cases where it is particularly advantageous or necessary.

The invention thus achieves the proposed objects offering the advantages described in relation to known solutions.

In particular, such advantages include the improved efficiency and reliability of tightening achieved using the self-locking nut of the invention, in combination with the constructional simplification shown in the method of manufacture thereof.

1. Self-locking nut for securing components for spectacles, comprising a body (8) with a through-hole (9), threaded internally and extending in an axial direction (X), wherein the body (8) has at least one recess (11) extending transversely to the axial direction (X) and intersecting the threaded hole (9) at least partially, the at least one recess (11) delimiting at least a first and a second portion (12, 13) of the body (8) joined together and axially separated from each other, and sections (12a, 13a) of the threaded hole (9) of the respective first and second portions (12, 13) are axially misaligned in relation to each other along the axial direction (X) and arranged to return in substantially reciprocal axial alignment when the portions (12, 13) are both screwed onto a threaded shank (16), an elastic deformation generated in the portions (12, 13) of the nut, as a result of the return to the aligned position of the threaded sections, being such as to increase a tightening action of the nut on the threaded shank.

2. Nut according to claim 1, wherein the at least one recess (11) extends perpendicular to the direction of axial development (X) of the nut.

3. Nut according to claim 1, wherein the threaded section (12a) of one of the portions (12, 13) is coaxial with the axis of the nut, the threaded section (13a) of the other portion being misaligned with a preset angulation in relation to the direction of axial development (X) of the nut.

4. Nut according to claim 1, wherein the at least one recess (11) extends radially beyond the corresponding median diametral plane of the nut containing the main axis of the nut.

5. Nut according to claim 1, wherein the portions (12, 13) of the nut, in the configuration with the respective threaded sections (12a, 13a) in reciprocal misalignment, extend to converge towards each other from a part diametrically opposite a connection area (14) not affected by the recess (11).

6. Nut according to claim 1, comprising a pair of recesses (11) axially separated from each other and such as to define a first (12), second (13) and third portion (17) of the nut, the third portion (17) being between the recesses (11), the first and second portions (12, 13) are defined by parts which are axially opposite the third portion (17).

7. Nut according to claim 6, wherein the recesses (11) extend from diametrically opposite areas of the body (8) and extend radially beyond a diametral median plane transverse to the direction of radial development.

8. Nut according to claim 6, wherein a threaded section of the third portion (17) is coaxial with the axis of the nut, the sections (12a, 13a) of the threaded hole of the first and second portions (12, 13) being misaligned, along the axial direction (X), in relation to the threaded section of the third portion (17) and arranged so as to return in substantially reciprocal axial alignment when all the portions (12, 13, 17) are screwed onto a threaded shank (16), the elastic deformation generated in the first and second portions (12, 13) of the nut as a result of a return to the aligned position of the threaded sections (12a, 13a) being such as to increase a tightening action of the nut on the threaded shank.

9. Nut according to claim 8, wherein the threaded sections (12a, 13a) of the first and second portions (12, 13) are inclined with a same angulation in relation to the axis of the third portion (17) of the nut.

10. Nut according to claim 8, wherein the first and second portions (12, 13) of the nut, in the configuration with their respective threaded sections (12a, 13a) misaligned in relation to the third portion (17), extend to converge towards the third portion (17) from a part diametrically opposite a connection area (14) with the third portion, not affected by the corresponding recess (11).

11. Nut according to one or more of claim 5, wherein the nut body (8) is obtained by bending an elongated base (8a), the first and second portions (12, 13) as well as the connecting area (14) between the portions are substantially coplanar with each other.

12. Nut according to claim 11, wherein the elongated base (8a) has incisions (20) between each of the first and second portions (12, 13) and the connecting area (14), the incisions (20) designed to facilitate the bending of the base (8a).

13. Method of manufacture of a self-locking nut for securing components for spectacles comprising a nut body (8) with an axial through-hole (9), threaded internally, the method comprising:
providing in the nut body (8) at least a first and a second portion (12, 13) that are axially aligned as well as reciprocally separated by an recess (11) extending transversely to an axis (X) of the nut until reaching a connection area (14) of the portions (12, 13) and at least partially intersecting the hole (9);
deforming by bending at least one of the portions (12, 13), so that the main parts of the respective threaded sections (12a, 13a) of the corresponding first and second portion (12, 13) remain misaligned in relation to each other along the axial direction (X), so as to return in substantially reciprocal alignment when the portions (12, 13) are both screwed onto a threaded shank (16), the action of elastic return in an aligned position being such as to increase tightening of the nut on the threaded shank.

14. Method according to claim 13, wherein the transverse recess (11) is made by cutting the nut and subsequently bending one (13) of the portions of the nut in the direction of the other portion (12).

15. Method according to claim 14, wherein subsequent to the deformation by bending, a tempering heat treatment is applied to the portions (12, 13) in reciprocal misalignment.

16. Method according to claim 13, wherein two recesses (11) are made in the body (8) by cutting the nut transversely, the recesses (11) are axially separated so as to define a first (12), a second (13) and a third portion (17) of the nut, the third portion (17) being between the recesses (11), the first and the second portion (12, 13) being defined by parts that are axially opposite the third portion (17), and the first and the second portions (12, 13) are deformed by bending towards the third portion (17), so that the main parts of the respective threaded sections (12a, 13a) of the corresponding first and second portions are misaligned in relation to the threaded section of the third portion (17), along the axial direction (X), so as to return in substantially reciprocal alignment when all the portions (12, 13, 17) are screwed onto a threaded shank (16), an action of elastic return in an aligned position being such as to increase a tightening of the nut on the threaded shank.

17. Method according to claim 16, wherein the cuts required to achieve the recesses (11) are made on the nut from respective diametrically opposite areas, the corresponding connection area (14) between the first (12) and third portions (17) and between the second (13) and third portions (17) is defined by diametrically opposed and axially separated parts.

18. Method according to claim 16, wherein subsequent to the bending deformation of the first and second portions (12, 13) a tempering heat treatment is applied to the portions in reciprocal misalignment.

19. Method according to claim 13, wherein the body (8) is made from an elongated base (8a) that contains comprises, coplanar to each other, the first and second portions (12, 13) as well as a connection area (14) between the portions (12, 13), each first and second portion including a threaded through-hole, the recess (11) obtained by subsequent bending of the base (8a), at the connection area (14), until the portions (12, 13) are brought into a position of substantially facing one another as well as in a reciprocal separated relation, the relative positioning between the portions (12, 13) being such that main sections (12a, 13a) of the threaded holes of each portion (12, 13) are misaligned in relation to each other.

20. Method according to claim 19, wherein incisions (20) are made in the elongated base (8a) where the connection area (14) joins each respective portion so as to facilitate bending of the connection area (14).

21. Method according to claim 19, further comprising a heat treatment stage subsequent to bending the elongated base (8a).

22. Method according to claim 19 wherein the elongated base (8a) comprising the portions (12, 13) is obtained by cutting a sheet element.

23. Self-locking nut for securing components for spectacles, comprising a body (8) with an internally-threaded through-hole (9) extending along an axial direction (X), wherein the body (8) has at least one longitudinal recess (11) extending parallel to the axial direction (X) and intersecting the threaded hole (9), the at least one recess (11) delimiting at least a first and a second portion (12, 13) of the body (8) extending away from the recess, a threaded diameter of the axial hole is smaller than a diameter of a screw onto which the nut is to be screwed, an elastic deformation caused during screwing due to an effect of the difference in the mating thread diameters, and tending reciprocally to separate the portions of the nut, being such as to increase a tightening action of the nut on the screw.

24. Nut according to claim 23, wherein the recess extends along an entire longitudinal development of the body and is open at opposite axial ends thereof.

25. Nut according to claim 23 wherein the recess is made by cutting the nut body.
